(19) United States
(12) Patent Application Publication
(10) Pub. No.: US 2025/0145765 A1
(43) Pub. Date: May 8, 2025

(54) PROCESS AND APPARATUS FOR THE PURIFICATION OF POLYETHERKETONEKETONE

(71) Applicant: Gharda Chemicals Limited, Maharashtra (IN)

(72) Inventors: Prakash D. TRIVEDI, Thane (IN); Shrikant A. MAHAJAN, Thane (IN); Hemant Y. PARDESHI, Thane (IN); Atulkumar R. RAJA, Gujrat (IN)

(21) Appl. No.: 18/387,996

(22) Filed: Nov. 8, 2023

(51) Int. Cl. C08G 65/46; B01J 19/00

(52) U.S. Cl. CPC C08G 65/46; B01J 19/0013; B01J 19/0066; B01J 2219/00094; B01J 2219/00099

(57) ABSTRACT

The present disclosure relates to a process and an apparatus for the purification of polyetherketoneketone (PEKK). The process involves purifying the PEKK by using a solvent with continuous reflux to obtain the purified PEKK with enhanced product characteristics. The process of the present disclosure is simple, and economical, reduces the solvent usage and time for purification, and produces purified PEKK with comparatively high yield and purity.

### FIELD

The present disclosure relates to a process and an apparatus for the purification of polyetherketoneketone (PEKK).

### BACKGROUND

The background information herein below relates to the present disclosure but is not necessarily prior art.

PEKK is a semi-crystalline polymer and tends to crystalize out of solvent used, generally ODCB (Ortho dichloro benzene). During polymerization, AlCl₃ is generally used as a catalyst which gets complexed with the monomers and polymers. And it becomes difficult to separate AlCl₃ from the system to obtain PEKK of high purity. PEKK polymer is synthesized by using monomers such as 1,4 bis (phenoxy benzoyl) benzene (p-EKKE), 1,3 bis(phenoxybenzoyl) benzene (m-EKKE), terephthaloyl chloride (TPC), and isophthaloyl chloride (IPC). Alternately, the EKKE can be replaced by diphenyl ether (DPE) in the synthesis of PEKK, however, DPE and TPC are essential elements.

PEKK polymer is an elastic material that possesses good shock absorbance and fracture resistance. The PEKK polymer offers ultra-high performance in thermoplastic composites, known for its excellent mechanical strength, chemical resistance, and high thermal stability.

The PEKK polymer forms a series of terpolymers with EKKE (or DPE) monomer and TPC:IPC in a ratio in the range of 100:0 to 0:100. The polymerization process requires a large amount of AlCl₃, which largely remains in the polymer. In addition to AlCl₃, the polymer formed contains

The purification of PEKK to obtain a highly pure form of the polymer is laborious and a cost-intensive process. A high level of metal content in the PEKK polymer leads to the degradation of the polymer. The metal impurities include compounds of aluminium, iron, and sodium. Other impurities include unreacted monomer, oligomer, and some amount of residual solvent. PEKK polymer is generally processed at a temperature range of 300° C. to 420° C., the presence of a higher amount of impurities leads to degradation, cross-linking, and colour formation of the polymer.

Conventional methods for the purification of PEEK involve the use of various carboxylic acids for complexing the metal residues present in the crude PEKK followed by multiple washings. These conventional processes are able to reduce the use of solvent required for purification but fail to reduce the metallic impurities in the PEKK polymer. Further, these multiple washings require huge volumes of solvents affecting the financial viability of the purification process.

Therefore, there is felt a need to provide a process for the purification of PEKK polymer that mitigates the aforestated drawbacks or at least provide a reasonable alternative.

There is a need for a process for continuous treatment of PEKK, which reduces the time of treatments substantially, using less overall volume and number of solvents, and substantially improves the productivity of PEKK production, including cost of production.

### Objects

Some of the objects of the present disclosure, which at least one embodiment herein satisfies, are as follows:

An object of the present disclosure is to ameliorate one or more problems of the prior art or to at least provide a useful alternative.

Another object of the present disclosure is to provide a simple process for the purification of polyetherketoneketone.

Yet another object of the present disclosure is to provide a process for the purification of polyetherketoneketone that is more cost-efficient and environment friendly.

Still another object of the present disclosure is to provide a process that is continuous.

Still another object of the present disclosure is to provide a process for the purification of polyetherketoneketone that comparatively reduces the metallic impurities and usage of solvent.

Another object of the present disclosure is to provide an apparatus for the purification of polyetherketoneketone.

Other objects and advantages of the present disclosure will be more apparent from the following description, which is not intended to limit the scope of the present disclosure.

### SUMMARY

The present disclosure relates to a process and an apparatus for the purification of polyetherketoneketone. In an aspect, the process comprises the following steps
a. mixing PEKK containing impurities with a solvent in a solvent collection vessel;
b. stirring the PEKK and the solvent at a predetermined rpm to obtain a slurry mixture;
c. heating the slurry mixture at a first predetermined temperature to leach the impurities present in PEKK into solvent;
d. separately loading the solvent in a solvent vaporization vessel;
e. heating the solvent in the solvent vaporization vessel at a second predetermined temperature to vaporize the solvent in the solvent vaporization vessel;
f. leading the solvent vapours from the solvent vaporization vessel to a first condenser to condense the solvent vapours into the solvent collection vessel and ensuring the level of the solvent in the solvent collection vessel is always above the level of the slurry mixture;
g. filtering the slurry mixture in the solvent collection vessel to allow solvent loaded with impurities formed in the solvent collection vessel to flow into the solvent vaporization vessel;
h. circulating the solvent repeatedly between the solvent collection vessel and the solvent vaporization vessel;
i. drawing samples periodically of the solvent flowing into the solvent vaporization vessel until the solvent flowing from the solvent collection vessel to the solvent vaporization vessel contains impurities below a set threshold;
j. obtaining wet purified PEKK from the solvent collection vessel which has impurities below the set threshold;
k. drying the wet purified PEKK to obtain purified PEKK.

In an embodiment of the present disclosure, the solvent is methanol.

In an embodiment of the present disclosure, the process of stirring, the predetermined rpm is in the range of 300 rpm to 400 rpm.

In an embodiment of the present disclosure, the process of stirring is continuous throughout the purification process.

In an embodiment of the present disclosure, the first predetermined temperature is in the range of 60° C. to 64° C.

In an embodiment of the present disclosure, the impurities in the solvent loaded with impurities is at least one impurity selected from the group consisting of aluminium compounds, iron compounds, sodium compounds, ortho dichloro benzene (ODCB) molecules, monomers, and oligomers.

In an embodiment of the present disclosure, the aluminium compounds include aluminium hydroxide and aluminium chloride.

In an embodiment of the present disclosure, the second predetermined temperature is in the range of 64.7° C. to 75° C.

In an embodiment of the present disclosure, the circulation of solvent is carried out for a period of 20 hours to 36 hours.

In an embodiment of the present disclosure, the wet purified PEKK is dried at a temperature in the range of 100° C. to 180° C. for 20 hours to 30 hours.

In an embodiment of the present disclosure, further include the step of condensing residual vapours of solvent generated in the solvent collection vessel or received in the solvent collection vessel via the first condenser, in a second condenser fitted to the solvent collection vessel.

In an embodiment of the present disclosure, the threshold of impurities in the drawn sample is maintained for aluminium compounds to be less than 100 ppm, for iron compounds to be less than 30 ppm, and for sodium compounds to be less than 20 ppm.

In an embodiment of the present disclosure, the solvent loaded with impurities in the solvent vaporization vessel is periodically drained to remove solvent loaded with impurities, when the impurity level in the solvent exceeds a predetermined threshold.

In another aspect, an apparatus to purify crude polyetherketoneketone (PEKK) is provided. The apparatus comprises the solvent collection vessel for loading PEKK and the solvent; the solvent vaporization vessel for receiving the solvent, solvent vaporization vessel operatively positioned below solvent collection vessel; a stirring means for stirring the PEKK and the solvent in the solvent collection vessel at a predetermined rpm to form the slurry mixture; a first heating means for heating the slurry mixture in the solvent collection vessel; a second heating means for vaporizing the solvent in the solvent vaporization vessel; a first condenser fitted to the solvent collection vessel; a first conduit means connecting the solvent vaporization vessel to the first condenser to permit solvent vapours to flow from the solvent vaporization vessel to the first condenser, and is further configured to allow the vapours to condense in the first condenser and flow into the solvent collection vessel; a second condenser fitted to the solvent collection vessel is configured to receive residual vapours from the solvent collection vessel and the first condenser and is further configured to convert the received residual vapours to condensed solvent and is still further configured to allow the converted condensed solvent to flow back into the solvent collection vessel; a filtering arrangement is configured at the base of the solvent collection vessel to permit solvent loaded with impurities to flow out of the base of the solvent collection vessel; a second conduit means is configured to receive the solvent loaded with impurities flowing out of the base of the solvent collection vessel after passing through the filtering arrangement and transmit the solvent loaded with impurities to the solvent vaporization vessel; a branch formed in second conduit is configured to enable periodic drawing of samples of the solvent loaded with impurities for determining the threshold of impurities present in the drawn sample; and drying means for drying the wet purified PEKK obtained from the solvent collection vessel.

In an embodiment of the present disclosure, the stirring means comprises a stirrer connected to a motor configured to stir the PEKK and solvent in the solvent collection vessel to an rpm in the range of 300 rpm to 400 rpm.

In an embodiment of the present disclosure, the first heating means is a hot water jacket having means to control the temperature of the slurry mixture in the solvent collection vessel.

In an embodiment of the present disclosure, the second heating means is a liquid bath having means to control the temperature of the solvent in the solvent vaporization vessel to enable vaporization of the solvent in the vessel.

In an embodiment of the present disclosure, the filtering arrangement includes a filtration cloth mounted on a Teflon net to prevent particles greater than 25 microns from passing through the filtering arrangement.

In an embodiment of the present disclosure, the second conduit includes a first valve to control the flow of solvent loaded with impurities from the solvent collection vessel to the solvent vaporization vessel.

In an embodiment of the present disclosure, the second conduit includes a second valve for controlling the periodic drawing of samples of solvent loaded with impurities from the solvent collection vessel to the solvent vaporization vessel (200).

In an embodiment of the present disclosure, the solvent vaporization vessel also includes a stoppered neck for introducing solvent into the solvent vaporization vessel.

### BRIEF DESCRIPTION OF THE ACCOMPANYING DRAWING

The present disclosure will now be described with the help of the accompanying drawing, in which:

FIG. 1 illustrates the continuous extraction assembly in accordance with the present disclosure.

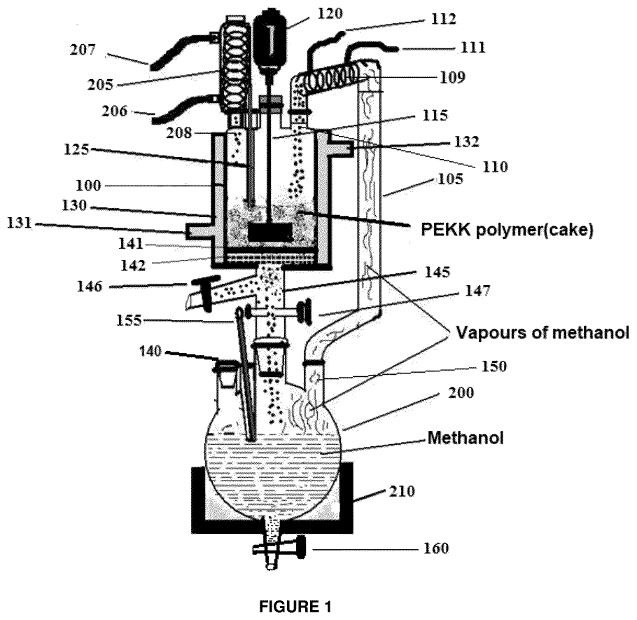

### LIST OF REFERENCE NUMERALS USED IN DETAILED DESCRIPTION AND DRAWINGS

100—Solvent collection vessel
105—Glass column attached to first condenser
109—First condenser
110—Outlet
111—First condenser inlet
112—First condenser outlet
115—Stirrer
120—Motor
125—First thermometer
130—Heating water jacket
131—Heating water jacket inlet
132—Heating water jacket outlet
140—Stopper
141—Filtration cloth
142—Teflon net
145—Second conduit (Cannula)
146—First valve
147—Second valve
150—Outlet of solvent vaporization vessel
155—Second thermometer
160—Third valve
200—Solvent vaporization vessel
205—Second condenser
206—Second condenser water inlet
207—Second condenser water outlet
208—Second condenser inlet to solvent collection vessel
210—Temperature controlled water bath

### DETAILED DESCRIPTION

The present disclosure relates to a process and an apparatus for the purification of polyetherketoneketone (PEKK).

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units, and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer, or section from another component, region, layer or section. Terms such as first, second, third, etc., when used herein do not imply a specific sequence or order unless clearly suggested by the present disclosure.

PEKK is a semi-crystalline polymer and tends to crystalize out of solvent used, generally ODCB (Ortho dichloro benzene). During polymerization, AlCl₃ is generally used as a catalyst which gets complexed with the monomers and polymers. And it becomes difficult to separate AlCl₃ from the system to obtain PEKK of high purity. PEKK polymer is synthesized by using monomers such as 1,4 bis (phenoxy benzoyl) benzene (p-EKKE), 1,3 bis(phenoxybenzoyl) benzene (m-EKKE), terephthaloyl chloride (TPC), and isophthaloyl chloride (IPC). Alternately, the EKKE can be replaced by diphenyl ether (DPE) in the synthesis of PEKK, however, DPE and TPC are essential elements.

The purification of PEKK to obtain a highly pure form of the polymer is laborious and a cost-intensive process. A high level of metal content in the PEKK polymer leads to the degradation of the polymer. The metal impurities include compounds of aluminium, iron, and sodium. Other impurities include unreacted monomer, oligomer, and some amount of residual solvent. PEKK polymer is generally processed at a temperature range of 300° C. to 420° C., the presence of a higher amount of impurities leads to degradation, cross-linking, and colour formation of the polymer.

Conventional methods for the purification of PEEK involve the use of various carboxylic acids for complexing the metal residues followed by multiple washings. These conventional processes were able to reduce the use of solvent required for purification but failed to reduce the metallic impurities in the PEKK polymer. Further, these multiple washings require huge volumes of solvents affecting the financial viability of the process.

The process of the present disclosure provides a simple process for the purification of PEKK and an apparatus that efficiently removes the impurities and provides higher purity to the final product.

In an aspect of the present disclosure, a process for the purification of PEKK is described in detail.

The process comprises the following steps

In a first step, PEKK containing impurities is mixed with a solvent in a solvent collection vessel.

In an embodiment of the present disclosure, the solvent is methanol.

In a second step, the PEKK and the solvent is stirred at a predetermined rpm to obtain a slurry mixture.

In an embodiment of the present disclosure, the predetermined rpm is in the range of 300 rpm to 400 rpm. In an exemplary embodiment of the present disclosure, the predetermined rpm is 350 rpm.

In an embodiment of the present disclosure, the process of stirring is continuous.

In a third step, the slurry mixture is heated at a first predetermined temperature to leach the impurities present in PEKK into the solvent.

In an embodiment of the present disclosure, the first predetermined temperature is in the range of 60° C. to 64° C. In an exemplary embodiment of the present disclosure, the first predetermined temperature is 64° C.

In a fourth step, separately loading the solvent in a solvent vaporization vessel (200) followed by heating at a second predetermined temperature to vaporize the solvent in the solvent vaporization vessel (200).

In an embodiment of the present disclosure, the second predetermined temperature is in the range of 64.7° C. to 75° C. In an exemplary embodiment of the present disclosure, the second predetermined temperature is 75° C.

In a fifth step, the solvent vapours generated from the solvent vaporization vessel (200) lead to a first condenser to condense the solvent vapours into the solvent collection vessel (100) and ensure the level of the solvent in the solvent collection vessel (100) is always above the level of the slurry mixture. The solvent level is maintained above the slurry mixture to maintain the equilibrium between the solvent and slurry mixture.

In a sixth step, the slurry mixture in the solvent collection vessel (100) is filtered to allow the solvent loaded with impurities formed in the solvent collection vessel (100) to flow into the solvent vaporization vessel (200).

In a seventh step, the solvent is circulated repeatedly between the solvent collection vessel (100) and the solvent vaporization vessel (200).

In an embodiment of the present disclosure, the circulation of solvent is carried out for a period of 20 hours to 36 hours.

In an eighth step, samples of the solvent flowing into the solvent vaporization vessel (200) are periodically drawn until the solvent flowing from the solvent collection vessel (100) to the solvent vaporization vessel (200) contains impurities below a set threshold.

In an embodiment of the present disclosure, the impurities is at least one impurity selected from the group consisting of aluminium compounds, iron compounds, sodium compounds, ortho dichloro benzene (ODCB) molecules, monomers, and oligomers.

In an embodiment of the present disclosure, set threshold of impurities in said drawn sample is maintained for aluminum compounds to be less than 100 ppm, for iron compounds to be less than 30 ppm, and for sodium compounds to be less than 20 ppm.

In a ninth step, the wet purified PEKK from the solvent collection vessel (100) which has impurities below the set threshold.

In an embodiment of the present disclosure, the wet purified PEKK is filtered

In a final step, the wet purified PEKK is dried to obtain purified PEKK.

In an embodiment of the present disclosure, the wet purified PEKK is dried at a temperature in the range of 100° C. to 180° C. for 20 hours to 30 hours.

In another aspect of the present disclosure, an apparatus to purify polyetherketoneketone (PEKK) is provided.

The apparatus comprises a solvent collection vessel (100), a solvent vaporization vessel (200), stirring means, a first heating means, a second heating means, a first condenser (109), a first conduit means, a second condenser (205), a filtering arrangement, a second conduit means, and drying means.

The solvent collection vessel (100) is defined as a cylindrical vessel for loading PEKK and a solvent. The solvent collection vessel (100) comprises a stirring means for stirring the PEKK and the solvent at a predetermined rpm to form a slurry mixture.

In an embodiment of the present disclosure, the stirring means comprises a stirrer (115) connected to a motor (120) configured to stir the PEKK and solvent in the solvent collection vessel (100) at an rpm in the range of 300 rpm to 400 rpm.

The solvent collection vessel (100) is further surrounded by a first heating means heating water jacket (130), and the heating water jacket comprises a heating water jacket inlet (131) and a heating water jacket outlet (132) for heating the slurry mixture. The solvent solvent collection vessel (100) also comprises a first thermometer (125) to monitor the temperature.

The solvent collection vessel (100) is configured to receive a first conduit means glass column attached to the first condenser (105), and the glass column attached to the first condenser (105) comprises an outlet (110), the glass column attached to the first condenser (105) connects the solvent vaporization vessel (200) to permit solvent vapours to flow from solvent vaporization vessel (200) to the first condenser (109) comprises a first condenser inlet (111) and first condenser outlet (112), and is configured to allow the vapours to condense in the first condenser (109) and flow into the solvent collection vessel (100).

The solvent collection vessel (100) is fitted with a second condenser (205) comprises a second condenser water inlet (206) and second condenser water outlet (207) configured to receive residual vapours from second condenser inlet to solvent collection vessel (208) in the solvent collection vessel (100) and from the first condenser (109) and further configured to convert the received residual vapours to condensed solvent and still further configured to allow the converted condensed solvent to flow back into the solvent collection vessel (100).

The solvent collection vessel (100) is configured with a filtering arrangement at the base of the solvent collection vessel (100) to permit the solvent loaded with impurities to flow out of the base of the solvent collection vessel (100).

In an embodiment of the present disclosure, the filtering arrangement includes a filtration cloth (141) mounted on a Teflon net (142) to prevent particles greater than 25 microns from passing through the filtering arrangement.

The solvent vaporization vessel (200) is operatively positioned below the solvent collection vessel (100). The solvent vaporization vessel (200) includes a stoppered neck (140) for introducing solvent into the solvent vaporization vessel (200). The solvent vaporization vessel (200) is partially covered in a second heating means (210) for vaporizing the solvent in the solvent vaporization vessel (200). Further, the solvent vaporization vessel (200) comprises a second thermometer (155) to record the temperature, an outlet of solvent vaporization vessel (150) to connect the glass column attached to first condenser (105) to allow the passage of vapours and a third valve (160) on the operating bottom to remove the contents.

In an embodiment of the present disclosure, the second heating means is a liquid bath (210) having means to control the temperature of the solvent in the solvent vaporization vessel (200) to enable vaporization of the solvent in the vessel (200).

The apparatus comprises a second conduit (145) configured to receive the solvent loaded with impurities flowing out of the base of the solvent collection vessel (100) after passing through the filtering arrangement and transmits the solvent loaded with impurities to the solvent vaporization vessel (200). Further, a branch formed in the second conduit (145) is configured to enable periodic drawing of samples of the solvent loaded with impurities for determining the threshold of impurities present in the drawn sample.

In an embodiment of the present disclosure, the second conduit (145) is in the form of a cannula.

In an embodiment of the present disclosure, the liquid bath is a temperature controlled water bath.

In an embodiment of the present disclosure, the second conduit (145) includes a first valve (146) for controlling the periodic drawing of samples of solvent loaded with impurities from the solvent collection vessel (100) to the solvent vaporization vessel (200).

In an embodiment of the present disclosure, the second conduit (145) includes a second valve (146) to control the flow of solvent loaded with impurities from the solvent collection vessel (100) to the solvent vaporization vessel (200).

The apparatus comprises a drying means for drying wet purified PEKK obtained from the solvent collection vessel (100).

Finally, the so obtained pure PEKK is having a yield of 92% and purity of 99.99%.

The process for the purification of PEKK of the present disclosure has significant commercial benefits owing to the reduction in the solvent, time required for purification, better recovery of the product, and enhanced product characteristics.

The foregoing description of the embodiments has been provided for purposes of illustration and is not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure is further described in light of the following experiments which are set forth for illustration purposes only and not to be construed for limiting the scope of the disclosure. The following experiments can be scaled up to industrial/commercial scale and the results obtained can be extrapolated to industrial scale.

### EXPERIMENTAL DETAILS

### Experiment 1: Preparation of PEKK with Multiple Grades

PEKK polymer was prepared by using p-EKKE (1,4-Bis (4-phenoxybenzoyl) benzene) or m-EKKE (1,3-Bis (4-phenoxybenzoyl) benzene) while varying the ratio of TPC:IPC (terpthaloyl chloride:isopthaloyl chloride). The ratio of TPC:IPC affects the basic thermal properties of these PEKK produced (grades), i.e. both Tg (glass transition temperature) and Tm (crystalline melting temperature) increase as the TPC content of PEKK increases. The thermal properties for various grades of PEKK are provided below in Table 1.

TABLE 1
Thermal properties of various grades of PEKK.

| TPC:IPC PEKK grade | Tg ° C. | Tm ° C. |
|---|---|---|
| 100:0 | 177 | 395 |
| 80:20 | 165 | 360 |
| 70:30 | 162 | 331 |
| 60:40 | 157 | 303 |
| 50:50 | 156 | 300 |
| 30:70 | 146 | 269 |
| 0:100 | 147 | 286 |

The reagent quantities w.r.t. ratio of TPC:IPC for various grades of PEKK based on 1 mole of p-EKKE or m-EKKE monomer is provided below in Table 2.

TABLE 2
TPC and IPC ratios for PEKK grades.

| Sr. | TPC:IPC | TPC | IPC |
|---|---|---|---|
| No. | PEKK grade | (moles) | (moles) |
| 1 | 100:0 | 1 | 0 |
| 2 | 80:20 | 0.6 | 0.4 |
| 3 | 70:30 | 0.4 | 0.6 |
| 4 | 60:40 | 0.2 | 0.8 |
| 5 | 50:50 | 0 | 1 |
| 6 | 30:70 | 0.6 | 0.4 |
| 7 | 0:100 | 0 | 1 |

In Sr. No 1 to 5, 1 mole of p-EKKE made from TPC was added along with given moles of TPC and IPC to maintain the ratio.
In Sr. No 6 and 7, 1 mole of m-EKKE made from IPC was added along with given moles of TPC and IPC to maintain the ratio.

The different grades of PEKK based on TPC and IPC quantities provided different enchainment ratios. The change in the molecular weights for a given TPC:IPC ratio was controlled by suitably modifying the quantity of end-capping agents such as p-chlorobenzoyl chloride (PCBC), benzoyl chloride (BC) or by adding an additional quantity of EKKE.

### Experiment 2: Purification of PEKK (Comparative Example)

The PEKK slurry obtained after the completion of polymerization was subjected to purification. The conventional process for purification includes the use of drowning the polymer slurry in methanol/HCl or methanol/H₂O/HCl followed by filtration to obtain a first wet cake. The process of drowning the polymer slurry breaks the AlCl₃ complex with polymer and then filtered. The first wet cake was further washed with aq. HCl (0.5 N) for 3-4 times to obtain a second wet cake, the aluminium compounds in the second wet cake were approx 15000 ppm. The so obtained second wet cake was washed with water 10 times to obtain a third wet cake having a pH of 6.5. The third wet cake was subjected to refluxing with MeOH/Acetyl acetone 5 times to obtain a fourth wet cake having an aluminium compounds content of <100 ppm. The fourth wet cake was washed with ortho dichlorobenzene (ODCB) 2 times to obtain pure PEKK of 99.99% purity (aluminium compounds content of <100 ppm, iron compounds content is <20 ppm, sodium compounds content is <10 ppm). The treatment of hot ODCB helps to remove the oligomer and unreacted monomer.

TABLE 3
Steps for the conventional process for the purification of PEKK

| | | | Solvent | | Aluminium |
|---|---|---|---|---|---|
| | | | lit/mol | Total | compounds |
| | | Number | for | Time | extraction in |
| SI. | | of | each | cycle, | the final |
| No. | Stage | treatment | treatment | (Hrs) | filtrate, ppm |
| 1 | Drowning in | 1 | 6.5 | 8 | 585000 |
| | methanol + | | | | |
| | Water + HCL | | | | |
| 2 | Azeotropic | 1 | NA | 8 | 186000 |
| | ODCB removal | | | | |
| 3 | DM water + HCl | 1 | 8 | 17 | 46000 |
| | treatments | | | | |
| 4 | DM water + HCl | 5 | 5 | 24 | 4000 |
| | treatments* | | | | |
| 5 | DM water | 10 | 5 | 60 | 3900 |
| | treatments | | | | |
| 6 | Methanol | 2 | 5 | 12 | 3500 |
| | treatments | | | | |
| 7 | Methanol + | 5 | 5 | 45 | 3000 |
| | acetylacetone | | | | |
| | treatments | | | | |
| 8 | Methanol | 6 | 8 | 36 | <100 |
| | treatments | | | | |
| 9 | DM water | 1 | 8 | 10 | NA |
| | treatments | | | | |
| 10 | ODCB treatment | 1 | 6 | 7 | NA |
| 11 | DM water | 1 | 8 | 17 | NA |
| | treatments | | | | |
| | Total | 32 | 189.5 | 236 | 100% |
| | | | lit/mole | hrs | aluminium |
| | | | | | compounds |
| | | | | | removed |

*Before 5 Methanol + Acetyl acetone treatments, metals in cake aluminium compounds =1347 ppm , iron compounds = 12 ppm , sodium compounds = 9 ppm
**After all treatments, metals in cake aluminium compounds = 80 ppm, iron compounds = 8ppm, sodium compounds = 6 ppm.

### Experiment 3: Purification of PEKK in Accordance with the Present Disclosure

640 gm of PEKK (TPC:IPC-60:40) was placed in the solvent collection vessel (100) followed by the addition of 1000 ml of methanol followed by stirring at a speed of 350 rpm to obtain a slurry mixture. The process of stirring is continued throughout the process. The slurry mixture was heated to 64° C. to leach the impurities present in PEKK into the solvent. Separately, 3000 ml of methanol was loaded in a solvent vaporization vessel (200), followed by heating to 75° C. to vaporize the solvent in the solvent vaporization vessel (200). The vapours from the solvent vaporization vessel (200) lead through the glass column attached to the first condenser (105), to the vapours condense to form methanol into the solvent collection vessel (100) through an outlet (110). The condensed solvent at 64° C. was mixed with the slurry mixture. The slurry mixture in the solvent collection vessel (100) was filtered through the filtering arrangement to allow the methanol loaded with impurities to flow into the solvent vaporization vessel (200). The filtering arrangement selectively retains the PEKK in the solvent collection vessel (100). The samples of methanol loaded with impurities passing from the solvent collection vessel (100) to the solvent vaporization vessel (200) were periodically drawn to test the impurity levels. The process of circulating the methanol from the solvent vaporization vessel (200) to the solvent collection vessel (100) and periodic testing of methanol loaded with impurities is continued till the impurities reach the below set threshold. On attaining the impurities in the set threshold limit, the solvent from the solvent collection vessel (100) is separated to obtain wet purified PEKK. The wet purified PEKK was dried at 150° C. for 24 hours to obtain purified PEKK.

The desired level of impurities for PEKK resin is provided in the table below

TABLE 4
Desired level of impurities

| Metals | Concentration | Method |
|---|---|---|
| aluminium compounds | <100 ppm | ICP |
| iron compounds | <30 ppm | ICP |
| sodium compounds | <20 ppm | ICP |

### Experiment 4-12: Purification of PEKK

The process for the purification of the PEKK was conducted similar to experiment 3 with varying PEKK grades and extraction times. The results are illustrated below in Table 4.

TABLE 5
Gel permeation chromatography (GPC) Molecular weights of PEKK

| | | | Mn | |
|---|---|---|---|---|
| | | | (number | MwD |
| | | Mw | average | (molecular |
| Sr. | | (molecular | molecular | weight |
| No. | Sample Name(T:I) | weight) | weight) | distribution) |
| 1 | Experiment no. 3 (60:40) | 1,06,720 | 35,455 | 3.01 |
| 2 | Experiment no. 4 (100:0) | 66,940 | 22,775 | 2.93 |
| 3 | Experiment no. 5 (80:20) | 79,568 | 28,209 | 2.82 |
| 4 | Experiment no. 6 (70:30) | 83036 | 27771 | 2.99 |
| 5 | Experiment no. 7 (50:50) | 71,530 | 24,430 | 2.94 |
| 6 | Experiment no. 8 (30:70) | 115393 | 37590 | 3.18 |
| 7 | Experiment no. 9 (0:100) | 1,00,115 | 30,165 | 3.31 |
| 8 | Experiment no. 10 (60:40) | 82,871 | 25,838 | 3.20 |
| 9 | Experiment no. 11 (60:40) | 90,920 | 31,790 | 2.86 |
| 10 | Experiment no. 12 (60:40) | 1,02,135 | 30,490 | 3.35 |

TABLE 6
Effect of extraction time on metal reduction in PEKK cake.

| | | Continuous | Metals | | |
|---|---|---|---|---|---|
| Ex- | | extraction | Aluminium | Iron | Sodium |
| periment | | in | compounds | compounds | compounds |
| No. | Grade | Hrs | (ppm) | (ppm) | (ppm) |
| 3 | 60:40 | 16 | 171 | 28 | 18 |
| | | 24 | 82 | 12 | 11 |
| 4 | 100:0 | 16 | 173 | 20 | 8 |
| | | 24 | 176 | 17 | 8 |
| | | 32 | 99 | 20 | 8 |
| 5 | 80:20 | 16 | 62 | 16 | 3 |
| 6 | 70:30 | 24 | 68 | 17 | 13 |
| 7 | 50:50 | 16 | 1041 | 46 | 30 |
| | | 24 | 66 | 30 | 16 |
| 8 | 30:70 | 16 | 68 | 17 | 13 |
| | | 24 | 41 | 10 | 13 |
| 9 | 0:100 | 16 | 100 | 21 | 9 |
| | | 24 | 31 | 6 | 7 |
| 10 | 60:40 | 16 | 1082 | 32 | 16 |
| | | 24 | 98 | 20 | 10 |
| 11 | 60:40 | 24 | 923 | 29 | 12 |
| | | 32 | 80 | 9 | 4 |

It is evident from the above data that the process of the present disclosure effectively removes all three major metal impurities i.e. aluminium compounds, iron compounds, and sodium compounds content in the PEKK to the standard level after continuous purification of 24 hours to 32 hours.

The ash and metal compounds content of the PEKK after purification was evaluated by Inductively Coupled Plasma (ICP) method and the results are provided below

TABLE 7
Ash and metal compounds data of PEKK after
the continuous extraction process

| Experiment no. | | Metals by ICP (ppm) | | |
|---|---|---|---|---|
| (TPC: | | Aluminium | Iron | Sodium |
| IPC) | Ash % | compounds | compounds | compounds |
| 3 (60:40) | <0.05 | 82 | 11 | 10 |
| 4 (100:0) | 0.099 | 99 | 20 | 8 |
| 5 (80:20) | <0.05 | 62 | 16 | 3 |
| 6 (70:30) | <0.05 | 68 | 17 | 13 |
| 7 (50:50) | <0.05 | 66 | 33 | 16 |
| 8 (30:70) | <0.05 | 41 | 10 | 13 |
| 9 (0:100) | <0.05 | 31 | 6 | 7 |
| 10 (60:40) | <0.05 | 98 | 20 | 6 |
| 11 (60:40) | <0.05 | 80 | 9 | 4 |
| 12 (60:40) | <0.05 | 43 | 26 | 8 |

These data show that even at different Mw and Mn and for different TPC:IPC ratios, the batches had metals within specifications after continuous extraction with MeOH.

The thermal stability of the PEKK obtained after purification was further evaluated for its thermal stability at 380° C., and the melt viscosity at 6 min and 30 min and at 0.1 Hz and 100 Hz were evaluated. The details are provided below in Table 7.

TABLE 8
Thermal stability data of PEKK at 380° C.
PEKK thermal stability TA-DHR-2, Frequency Sweep

| | Melt viscosity | | Melt viscosity | Melt viscosity | | Melt viscosity |
|---|---|---|---|---|---|---|
| | (Pa · s) at 0.1 Hz | | Ratio | (Pa · s) at 100 Hz | | Ratio |
| | 6 min | 30 min | 30 min ÷ 6 min | 6 min | 30 min | 30 min ÷ 6 min |
| Exp-3 | 621 | 1995 | 3.21 | 226 | 219 | 0.97 |
| Exp-4* | 84 | 607 | 7.22 | — | — | — |
| Exp-5 | 882 | 10,574 | 12 | 205 | 153 | 0.8 |
| Exp-6 | 980 | 5,077 | 5.1 | 163 | 128 | 0.8 |
| Exp-7 | 528 | 1574 | 2.98 | 157 | 155 | 0.99 |
| Exp-8 | 1697 | 6487 | 3.82 | 320 | 228 | 0.71 |
| Exp-9 | 151 | 663 | 4.39 | 71 | 66 | 0.93 |
| Exp-10 | 627 | 1864 | 2.97 | 224 | 157 | 0.7 |
| Exp-11 | 656 | 2050 | 3.13 | 235 | 223 | 0.95 |

*For 100:0 thermal stability done at 420° C.

TABLE 8
Thermal stability of PEKK 60:40 batches Continuous
Vs Non-continuous extraction.

| | Exp. | EXP. | EXP. |
|---|---|---|---|
| PEKK (60:40) | No. 3 | No. 11 | No. 2 |
| Melt viscosity (Pa · s) at 0.1 Hz, 6 min | 621 | 656 | 2021 |
| Melt viscosity (Pa · s) at 0.1 Hz, 30 min | 1995 | 2050 | 7377 |
| Ratio (30 min ÷ 6 min) | 3.21 | 3.13 | 3.62 |
| Melt viscosity (Pa · s) at 100 Hz, 6 min | 226 | 235 | 330 |
| Melt viscosity (Pa · s) at 100 Hz, 30 min | 219 | 223 | 182 |
| Ratio (30 min ÷ 6 min) | 0.97 | 0.95 | 0.55 |

It is evident from the above tables that the process parameters result in consistent performance producing the pure PEKK with enhanced product characteristics like melt viscosity with a yield greater than 90% and purity of 99.99%.

### Technical Advancements

The present disclosure described hereinabove has several technical advantages including, but not limited to, the realization of a process for the purification of a polyetherketoneketone that:
is cost-efficient;
provides PEKK of high purity and thermal stability;
is a simple process for the purification of PEKK;
is effective in removing impurities for all PEKK grades;
recycles the solvent, thus reducing solvent wastage;
reduces the time required for purification and increases productivity;
environment friendly; and
produces PEKK essentially free of metallic compound impurities such as aluminium compounds, iron compounds, and sodium compounds in comparison to conventional processes.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A process for purifying polyetherketoneketone (PEKK), said process comprising the following steps:
a. mixing PEKK containing impurities with a solvent in a solvent collection vessel (100);
b. stirring said PEKK and said solvent at a predetermined rpm to obtain a slurry mixture;
c. heating said slurry mixture at a first predetermined temperature to leach the impurities present in PEKK into solvent;
d. separately loading said solvent in a solvent vaporization vessel (200);
e. heating said solvent in the solvent vaporization vessel (200) at a second predetermined temperature to vaporize the solvent in said solvent vaporization vessel (200);
f. leading the solvent vapours from said solvent vaporization vessel (200) to a first condenser to condense said solvent vapours into the solvent collection vessel (100) and ensuring the level of the solvent in solvent collection vessel (100) is always above the level of said slurry mixture;
g. filtering said slurry mixture in the solvent collection vessel (100) to allow solvent loaded with impurities formed in the solvent collection vessel (100) to flow into the solvent vaporization vessel (200);
h. circulating said solvent repeatedly between said solvent collection vessel (100) and said solvent vaporization vessel (200);
i. drawing samples periodically of the solvent flowing into said solvent vaporization vessel (200) until the solvent flowing from the solvent collection vessel (100) to the solvent vaporization vessel (200) contains impurities below a set threshold;
j. obtaining wet purified PEKK from the solvent collection vessel (100) which has impurities below the said set threshold; and
k. drying said wet purified PEKK to obtain purified PEKK.

2. The process as claimed in claim 1, wherein said solvent is methanol.

3. The process as claimed in claim 1, wherein said predetermined rpm is in the range of 300 rpm to 400 rpm.

4. The process as claimed in claim 1, wherein said stirring is continuous throughout the purification process.

5. The process as claimed in claim 1, wherein said first predetermined temperature is in the range of 60° C. to 64° C.

6. The process as claimed in claim 1, wherein said impurities is at least one impurity selected from the group consisting of aluminium compounds, iron compounds, sodium compounds, ortho dichloro benzene (ODCB) molecules, monomers, and oligomers.

7. The process as claimed in claim 1, wherein said second predetermined temperature is in the range of 64.7° C. to 75° C.

8. The process as claimed in claim 1, wherein the circulation of solvent is carried out for a period of 20 hours to 36 hours.

9. The process as claimed in claim 1, wherein said wet purified PEKK is dried at a temperature in the range of 100° C. to 180° C. for 20 hours to 30 hours.

10. The process as claimed in claim 1, which includes the step of condensing residual vapours of solvent generated in said solvent collection vessel (100) or received in the solvent collection vessel (100) via the first condenser, in a second condenser (205) fitted to the solvent collection vessel (100).

11. The process as claimed in claim 6, wherein said set threshold of impurities in said drawn sample is maintained for aluminum compounds to be less than 100 ppm, for iron compounds to be less than 30 ppm, and for sodium compounds to be less than 20 ppm.

12. The process as claimed in claim 1, wherein said solvent loaded with impurities in said solvent vaporization vessel (200) is periodically drained to remove solvent loaded with impurities, when the impurity level in said solvent exceeds a predetermined threshold.

13. An apparatus to purify polyetherketoneketone (PEKK), said apparatus comprising:
a. a solvent collection vessel (100) for loading PEKK and a solvent;
b. a solvent vaporization vessel (200) for receiving the solvent, said solvent vaporization vessel (200) operatively positioned below solvent collection vessel (100);
c. stirring means for stirring the PEKK and the solvent in the solvent collection vessel (100) at a predetermined rpm to form a slurry mixture;
d. a first heating means for heating said slurry mixture in said solvent collection vessel (100);
e. a second heating means for vaporizing said solvent in said solvent vaporization vessel (200);
f. a first condenser fitted to said solvent collection vessel (100);
g. a first conduit means connecting said solvent vaporization vessel (200) to said first condenser to permit solvent vapours to flow from said solvent vaporization vessel (200) to said first condenser, and further configured to allow said vapours to condense in said first condenser and flow into said solvent collection vessel (100);
h. a second condenser fitted to said solvent collection vessel (100) configured to receive residual vapours from said solvent collection vessel (100) and said first condenser and further configured to convert said received residual vapours to condensed solvent and still further configured to allow the converted condensed solvent to flow back into the solvent collection vessel (100);
i. a filtering arrangement configured at the base of the solvent collection vessel (100) to permit solvent loaded with impurities to flow out of the base of said solvent collection vessel (100);
j. a second conduit (145) means configured to receive the solvent loaded with impurities flowing out of the base of said solvent collection vessel (100) after passing through said filtering arrangement and transmit said solvent loaded with impurities to said solvent vaporization vessel (200);
k. a branch formed in said second conduit (145) configured to enable periodic drawing of samples of said solvent loaded with impurities for determining the threshold of impurities present in said drawn sample; and
l. drying means for drying said wet purified PEKK obtained from said solvent collection vessel (100).

14. The apparatus as claimed in claim 13, said stirring means comprises a stirrer (115) connected to a motor (120) configured to stir the PEKK and solvent in said solvent collection vessel (100) at an rpm in the range of 300 rpm to 400 rpm.

15. The apparatus as claimed in claim 13, wherein said first heating means is a hot water jacket (130) having means to control the temperature of the slurry mixture in said solvent collection vessel (100).

16. The apparatus as claimed in claim 13, wherein said second heating means is a liquid bath (210) having means to control the temperature of the solvent in said solvent vaporization vessel (200) to enable vaporization of said solvent in the vessel (200).

17. The apparatus as claimed in claim 13, wherein said filtering arrangement includes a filtration cloth (141) mounted on a Teflon net (142) to prevent particles greater than 25 microns from passing through said filtering arrangement.

18. The apparatus as claimed in claim 13, wherein the second conduit (145) includes a first valve (146) for controlling the periodic drawing of samples of solvent loaded with impurities from said solvent collection vessel (100) to said solvent vaporization vessel (200).

19. The apparatus as claimed in claim 13, wherein said second conduit (145) includes a second valve (147) to control the flow of solvent loaded with impurities from said solvent collection vessel (100) to said solvent vaporization vessel (200).

20. The apparatus as claimed in claim 13, wherein said solvent vaporization vessel (200) also includes a stoppered neck (140) for introducing solvent into said solvent vaporization vessel (200).
